(19) United States
(12) Patent Application Publication
(10) Pub. No.: US 2008/0198372 A1
(43) Pub. Date: Aug. 21, 2008

(54) VEHICLE HEADLIGHT WITH IMAGE DISPLAY

(75) Inventor: Shaoher X. Pan, San Jose, CA (US)

Correspondence Address: FISH & RICHARDSON P.C., PO BOX 1022, MINNEAPOLIS, MN, 55440-1022, US

(73) Assignee: SPATIAL PHOTONICS, INC., Sunnyvale, CA (US)

(21) Appl. No.: 11/677,482

(22) Filed: Feb. 21, 2007

(51) Int. Cl. G01M 11/06

(52) U.S. Cl. 356/121

(57) ABSTRACT

A vehicle includes a headlight comprising a light source configured to emit light and a device to produce an image pixel in a display image in front of the vehicle. The image projected by the headlight can provide the driver with information, such as onto a roadway on which the vehicle is traveling.

### BACKGROUND

The present disclosure relates to a vehicle headlight.

Referring to FIGS. 1 and 2, a vehicle 100 usually has one or more headlights 110 and 111 in the front for illuminating road surfaces in the dark and in the rain or snow storms. A headlight 110 can include a light bulb 120 and a mirror 121. The light bulb 120 can, for example, be a halogen bulb or a Xenon bulb. The light bulb can emit light in different colors such as arctic white, hyper white, pure blue, purple, or yellow. The mirror 121 can direct light 131-133 emitted by the light bulb 120 out in front of the vehicle. The power applied to the light bulb 120 can be turned on or off by an electric switch under the control of the driver of the vehicle.

### SUMMARY OF THE INVENTION

In a general aspect, the present invention relates to a vehicle including a headlight comprising a light source configured to emit light and a spatial light modulator (SLM) including a two-dimensional array of pixel cells each of which is configured to produce an image pixel in a display image in front of the vehicle.

In another general aspect, the present invention relates to a vehicle including a headlight comprising a light source configured to emit light and a spatial light modulator (SLM) including a two-dimensional array of pixel cells each of which is configured to produce an image pixel in a display image in front of the vehicle; a computer device configured to store first data about the vehicle and driving conditions; an antenna configured to receive wireless signals; a receiver coupled to the antenna and is configured to extract second data from the wireless signals; and a display driver configured to control the two-dimensional array of pixel cells in response to at least one of the first data and the second data.

Implementations of the system may include one or more of the following. One of the pixel cells in the SLM is configured to reflect the light emitted from the light source to form the image pixel in the display image. At least one of the pixel cells in the SLM can include a tiltable mirror supported by a substrate, wherein the tiltable mirror can be tilted to an “on” position to reflect the light emitted from the light source to form an image pixel in the display image and to be tilted to an “off” position to reflect the light emitted from the light source away from the display image. One of the pixel cells in the SLM can transmit the light emitted from the light source to form the image pixel in the display image. The SLM can include a transmissive liquid crystal device. The headlight can further include a mirror configured to reflect the light emitted from the light source toward the SLM. The headlight can further include a projection system configured to project light from the SLM to form image pixels in the display image in front of the vehicle. The display image can be formed on a road surface in front of the vehicle. The vehicle can further include a display driver configured to control the two-dimensional array of pixel cells to produce the display image in front of the vehicle. The vehicle can further include an antenna, a receiver and a display driver, wherein the antenna is configured to receive wireless signals, the receiver is coupled to the antenna and is configured to extract data from the wireless signals, and the display driver is configured to control the two-dimensional array of pixel cells in accordance with the data extracted from the wireless signal. The vehicle can further include a computer device configured to store data about the vehicle and driving conditions and a display driver configured to control the two-dimensional array of pixel cells in response to the data stored in the computer device. The light source can be a Xenon lamp, a halogen lamp, or a light emitting diode.

Embodiments may include one or more of the following advantages. A potential advantage of the disclosed headlights is that they can display information useful to the driver of the vehicle. Another potential advantage of the disclosed headlights is that the useful information is displayed in the front and outside of the vehicle, in a location where the driver is looking during driving. The driver can therefore see the information while watching the road conditions. If the information is safety related, driving safety may therefore be improved. A potential advantage of the disclosed vehicle which includes the headlights described herein is that information received from an external source can be timely displayed and seen by the driver to enable the driver to make better driving decisions.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and from a part of the specification, illustrate embodiments of the present invention and, together with the description, serve to explain the principles of the invention.

FIG. 1 illustrates an exemplary vehicle.

FIG. 2 is a schematic diagram of a conventional headlight.

FIG. 3A is a schematic diagram of an exemplified headlight having a transmissive-type spatial light modulator in accordance with the present specification.

FIG. 3B is a schematic diagram of a pixel cell in a transmissive-type spatial light modulator of FIG. 3A.

FIG. 4 is a schematic diagram of another exemplified headlight having a reflective-type spatial light modulator in accordance with the present specification.

FIG. 5 is a schematic diagram of a vehicle with headlights.

FIG. 6 is a schematic diagram of a vehicle with headlights projecting an image.

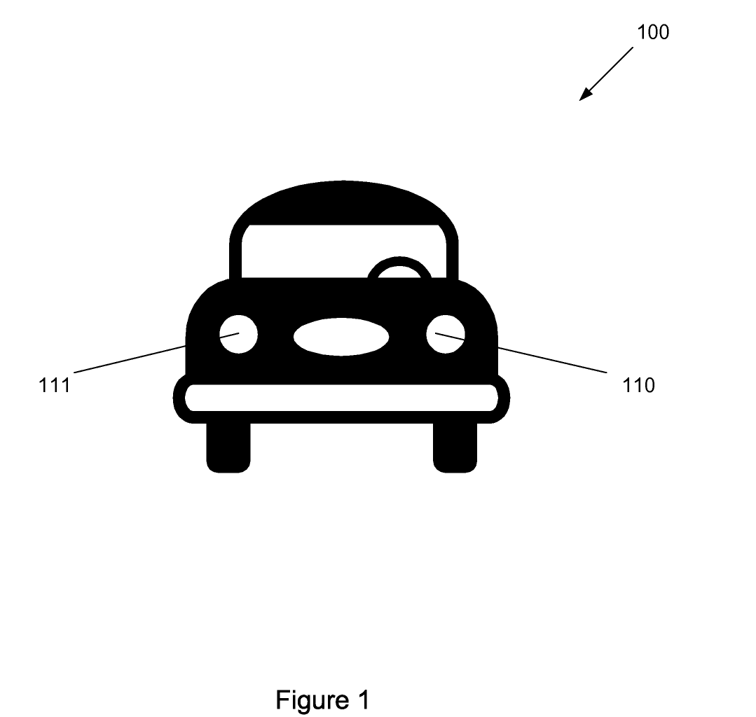

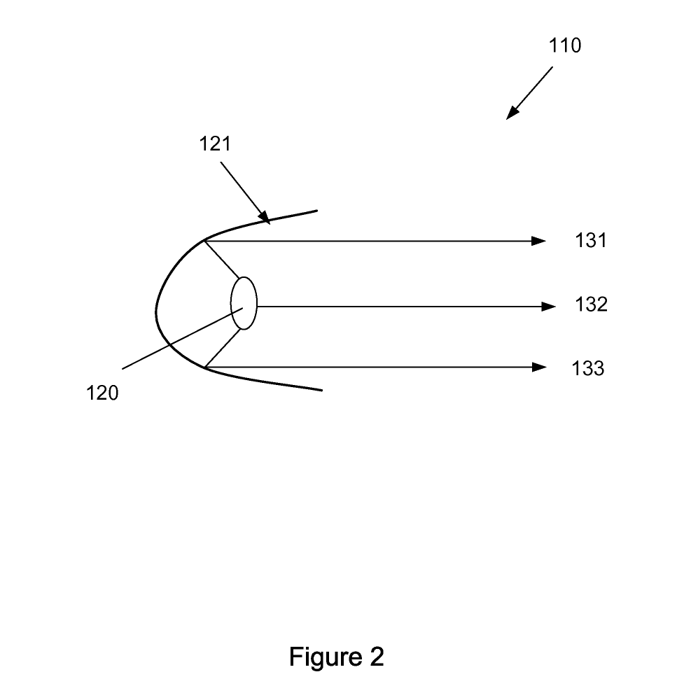

### DETAILED DESCRIPTION

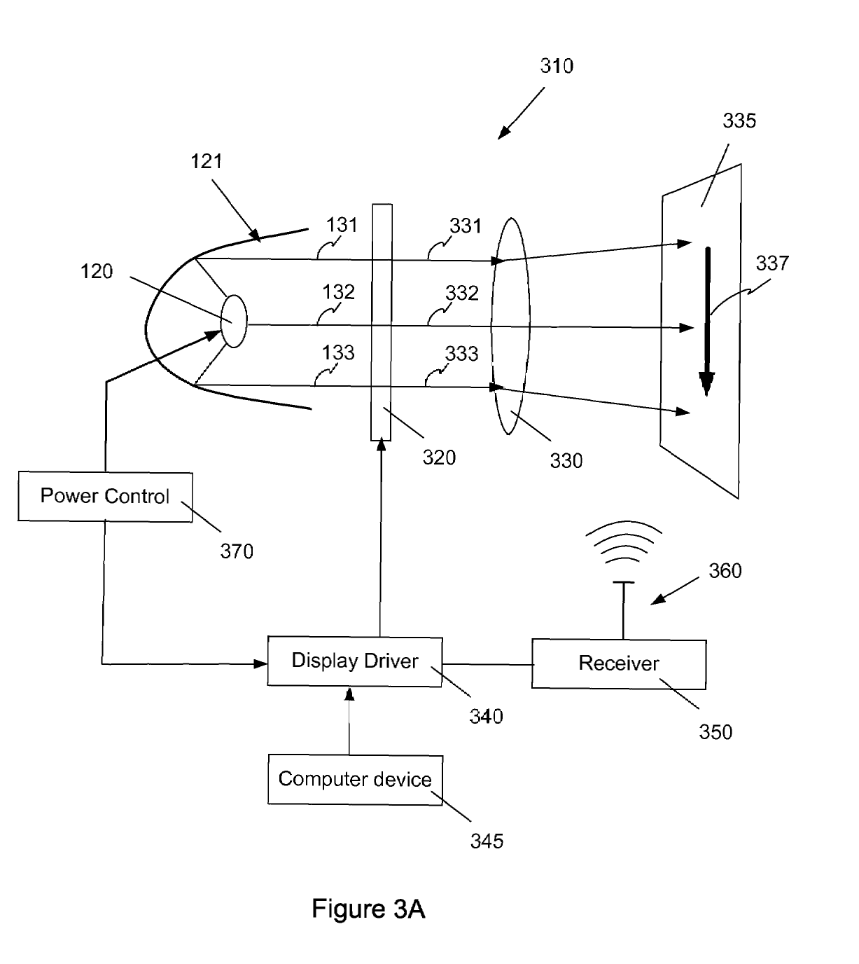

Referring to FIG. 3A, a headlight 310 for the vehicle can include a light bulb 120, a mirror 121, and a transmissive spatial light modulator (SLM) 320 in accordance with the present specification. The light 131-133 emitted by the light source 120 is directed by the mirror 121 to the transmissive spatial light modulator 320. The light source 120 can be a Xenon or halogen lamp, a light emitting diode, and other light emitting device. The transmissive SLM 320 includes a two-dimensional array of pixel cells (328, as shown in FIG. 3B) that can be controlled by a display driver 340. The intensity of the light (i.e., 131-133) illuminated at each of the pixels can be individually modulated under the control of the display driver 340 to produce spatially modulated light 331-333. The spatially modulated light 331-333 can be projected by a projection system 330 to form a display area 335 in front of the vehicle 100. The display area 335 can on the road surface in front of the vehicle.

An example of the transmissive SLM 320 is a transmissive liquid crystal device (LCD). A transmissive LCD includes a two-dimensional array of liquid crystal pixel cells. As shown in FIG. 3B, a pixel cell 328 in a transmissive LCD includes a pair of polarizers 321 and 322, a pair of electrodes 323 and 324, and liquid crystal material 325 in between the electrodes 323 and 324. The polarization directions of the polarizers 321 and 322 are typically aligned orthogonal relative to each other. The electric voltage across the electrodes 323 and 324 can be controlled by the display driver 340. The voltage values at the pixel cell 328 can determine the orientation of the liquid crystal material between the electrodes 323 and 324, which can modify the fraction of the light 131 that can transmit through the pixel cell in the transmissive LCD to produce light 331. In an “off” state, almost all the light 131 is blocked by the pixel cell 328. In an “on” state, a maximum fraction of light 131 can transmit through the pixel cell 328.

While the vehicle is driven, the display driver 340 can control all the pixel cells in the SLM 320 to allow maximum light transmission. The light 331-333 can thus illuminate the display area 335 similar to a conventional headlight (such as the headlight 110) without forming an image pattern.

The display driver 340 can also receive information from a receiver 350. The receiver 350 can be coupled with an antenna 360 that can receive wireless signals carrying information such as the locations of the vehicle, map and directions, weather conditions, news, advertisement, etc. The wireless signals can be received from a global positioning system (GPS), or wireless systems based on WIFI, WI-Max, cellular, or other wireless standard. The data are extracted from the wireless signals and the associated information can be displayed as an image pattern 337 in the display area 335. The display driver 340 can also receive data from a computer device 345 on the vehicle. The data can carry information such as time, driving conditions, e.g., the mileage and the speed of the vehicle etc., and the direction the vehicle is moving. The driving and control information can be displayed in the image pattern 337. When the driver turns on the blinker to indicate her intention to turn, an arrow can be displayed in the image pattern 337 indicate the turning direction for the vehicle.

The power applied to the light source 120 is controlled by a power control 370 that can turn the light source 120 on or off. Typically, the driver or the electronics of the vehicle sent the on or off instructions to the power control 370. The power control 370 can also provide power to the display driver 340 to allow spatial light modulation of the light 131-133 after the light source 120 is turned on. The power control 370 can also be controlled by the level of light outside the vehicle and/or humidity conditions. For example, the power control 370 can automatically turn on the headlights when it's dark or raining, and turn off the headlight 310 when it is bright or the rain stops.

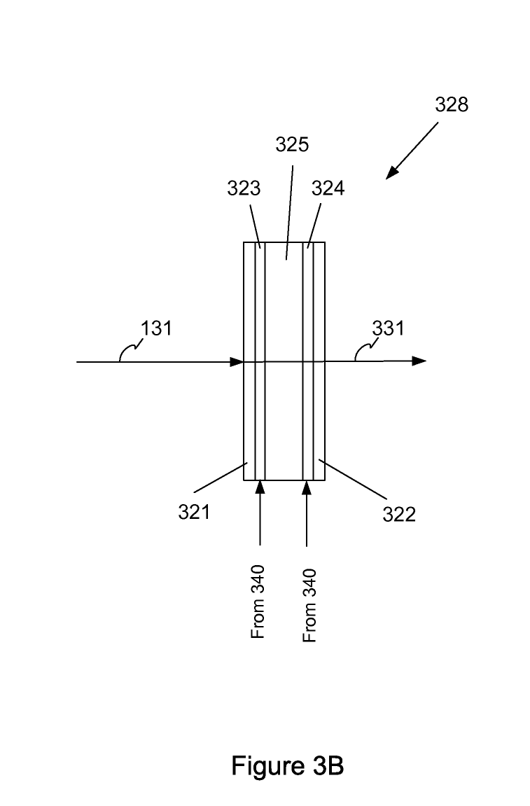

Referring to FIG. 4, a headlight 410 in accordance to the present specification can include a reflective-type SLM 420. The SLM 420 can include a micro mirror array. Each micro mirror includes tiltable mirror plate that can be tilted about a hinge that can be supported by a hinge support post connected to a substrate. The tilting of the tiltable mirror plate can be controlled by the display driver 340 in response to the data received from the receiver 350 or the computer device 345. The tiltable mirror plates can be tilted to “on” positions to reflect light 131-133 emitted from light source 310 to produce lights 331-333 that can form the image pattern 337 in the display area 335. The tiltable mirror plates can also be tilted to “off” positions to reflect light 131-133 emitted from light source 310 to produce lights 336-338 that travel away from the display area 335. Mechanical stops may be provided on the substrate for stopping the tilt movement of the mirror plates and define the orientations of the mirror plates at the “on” and the “off” positions. Details about the structures and operations of micro mirrors are disclosed for example in commonly assigned U.S. Pat. No. 7,167,298, titled “High contrast spatial light modulator and method”, U.S. patent application Ser. No. 10/974,461, titled “High contrast spatial light modulator”, filed Oct. 26, 2004, and U.S. patent application Ser. No. 11/553,886, titled “Non-contact micro mirrors”, filed Oct. 27, 2006, the contents of which are incorporated herein by reference.

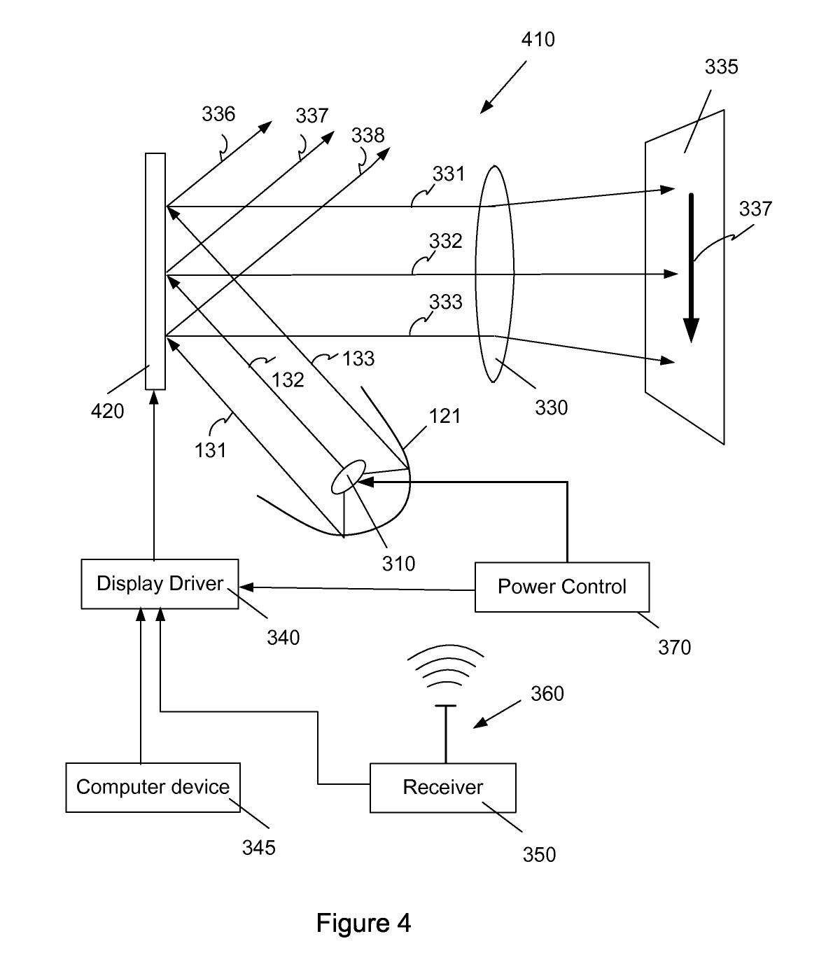

Referring to FIG. 5, a vehicle 500 equipped with headlights capable of projecting an image can project the image in one or more of a number of locations. The vehicle has two headlights 310L, 310R. The headlights 310L, 310R in FIG. 5 are low beam headlights, however the description of the headlights can be applied to other lights on the vehicle 500, such as high beams, fog lights, auxiliary lights or other lights. Light is projected in areas 505 for the driver to be able to see the roadway during low light conditions. The headlights 310L, 310R project the furthest light onto a driving surface at a location within about 350 feet from the headlights, in area 510. Area 510 can be between about 10 and 350 feet in front of the vehicle, such as between about 10 and 100 feet from the vehicle, between about 10 and 60 feet from the vehicle or between about 20 and 60 feet from the vehicle. Closer to the vehicle 500 is area 520, where the headlights 310L, 310R illuminate the roadway, but which is typically closer to the vehicle than the driver's vision is directed while driving. Area 520 can be between about 5 and 40 feet from the vehicle, such as between about 5 and 25 feet from the vehicle, or between about 5 and 20 feet from the vehicle. To the left and right of a center line that runs the length of the vehicle between the two headlights 310L, 310R are right area 530R and left area 530L.

In some embodiments, an image, such as a symbol, pattern, logo or message, is projected in only one area 510, 520, 530L or 530R at a time. This can reduce any distraction caused by the image to the driver while driving. Alternatively, multiple images can be projected at one time and in the same or different areas 510, 520, 530L or 530R. In some embodiments, the projected image is in area 510. Because the driving surface in area 510 is not as brightly lit as an area closer to the vehicle, the image may be made brighter than the surrounding headlight illumination. Alternatively, the image may be a different color, such as red, blue, green or yellow, or even dimmer than the surrounding headlight. Different colors can be achieved with a colored light source within the headlight 310L, 310R, or a component for providing colored light from a white light source, such as beam splitters.

In some embodiments, the vehicle 500 includes a sensor that senses when an oncoming vehicle is approaching, such as by detecting light from the oncoming vehicle. When an oncoming vehicle is detected, the image being displayed by the headlight can be tilted down or turned down or off, so that the oncoming vehicle does not view the image from vehicle 500. In some embodiments, the component that forms the image adjusts the image downwardly by adjusting the portion of the device that forms the image. When an SLM forms the image, the mirrors that were previously forming the image may be repositioned to create the light for the driving and mirrors that were previously used to form light for driving can be repositioned to form the image.

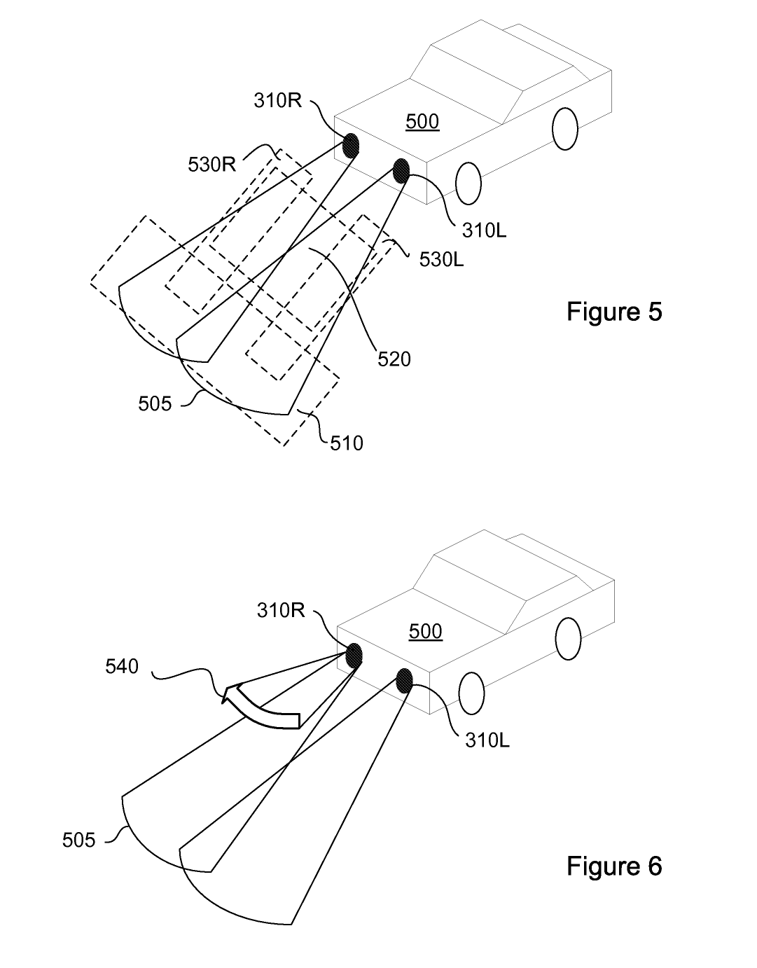

If the image is in areas 530L or 530R, the image may instruct the driver to turn or to focus his or her attention to that side of the vehicle. For example, as shown in FIG. 6, an image of a right arrow 540 in area 530R may instruct the driver to turn right or may inform the driver that a desired destination, such as a restaurant or parking space, is to the right of the vehicle. A number may be displayed with the arrow, indicated the distance to the turn or destination.

In some embodiments, the headlights are directional and turn as the car is turning. Because the image is projected by the headlight 310R or 310L, the image may turn with the directional headlight.

In addition to the light sources described herein, the light source can be a laser light. Laser lights may be able to provide better contrast with the light provided for the driver to see at night during driving. Or, the laser light may provide enough light for the driver to see the image during the day. When laser lights are used to form an image, any light that may be directed toward an oncoming vehicle can be shut off when the vehicle is approaching.

As noted above, to enhance the driver's ability to see the image, the image is made to contrast with the rest of the light provided by the headlight. Contrast can be provided by forming the image from a different color, outlining the image with dark space or no light, or forming a brighter image than surrounding light. These techniques can be used to increase contrast in any of the image areas 510, 520, 530L or 530R.

Another technique for enhancing the driver's ability to see the image is to provide simple, large images, such as symbols, for example, arrows, numbers or logos. Simple, large images also reduce the negative effects of keystoning that can occur because of the uneven road surface onto which the image is projected. In some embodiments, a corporate name is projected by the headlight, such as FORD, SONY or other corporate name or logo. The vehicle can therefore be used for advertising.

A potential advantage of the disclosed headlights is that they can display information useful to the driver of the vehicle. Another potential advantage of the disclosed headlights is that the useful information is displayed in the front and outside of the vehicle, in a location where the driver is looking during driving. The driver can therefore see the information while watching the road conditions. If the information is safety related, driving safety may therefore be improved. A potential advantage of the disclosed vehicle which includes the headlights described herein is that information received from an external source can be timely displayed and seen by the driver to enable the driver to make better driving decisions.

It is understood that the disclosed systems and methods are not limited to the spatial light modulators described above. Other types of SLM devices and other configurations can be used to in the disclosed vehicle headlight. The light emitted by the disclosed headlight can include different colors such as white, red, green, blue, yellow, magenta, and cyan. The display produced by the disclosed headlight can include color images. The color image can for example be formed by a color filter array that can produce green, red, and blue color pixels side by side in a two dimensional array. The color image can also be produced by a color wheel that can produce single color images (red, green, and blue) in sequence that can superimpose over each other to form color images. The disclosed headlight can in general include a light source that can include a light bulb, light emitting diode, and other light emitting devices. The disclosed vehicle can also include primary headlights and secondary headlights. For example, the disclosed vehicle can include primary headlights including SLMs, and secondary headlights that are similar to conventional headlights without SLMs.

What is claimed is:

1. A vehicle, comprising:
a headlight comprising a light source configured to emit light and a spatial light modulator (SLM) including a two-dimensional array of pixel cells each of which is configured to produce an image pixel in a display image in front of the vehicle.

2. The vehicle of claim 1, wherein one pixel cell of the pixel cells in the SLM is configured to reflect the light emitted from the light source to form the image pixel in the display image.

3. The vehicle of claim 2, wherein at least one of the pixel cells in the SLM comprises a tiltable mirror supported by a substrate, wherein the tiltable mirror is configured to be tilted to an “on” position to reflect the light emitted from the light source to form an image pixel in the display image and to be tilted to an “off” position to reflect the light emitted from the light source away from the display image.

4. The vehicle of claim 1, wherein one of the pixel cells in the SLM is configured to transmit the light emitted from the light source to form the image pixel in the display image.

5. The vehicle of claim 4, wherein the SLM comprises a transmissive liquid crystal device.

6. The vehicle of claim 1, wherein the headlight further comprises a mirror configured to reflect the light emitted from the light source toward the SLM.

7. The vehicle of claim 1, wherein the headlight further comprises a projection system configured to project light from the SLM to form image pixels in the display image in front of the vehicle.

8. The vehicle of claim 1, wherein the display image is formed on a road surface in front of the vehicle.

9. The vehicle of claim 1, further comprising a display driver configured to control the two-dimensional array of pixel cells to produce the display image in front of the vehicle.

10. The vehicle of claim 1, further comprising an antenna, a receiver and a display driver, wherein the antenna is configured to receive wireless signals, the receiver is coupled to the antenna and is configured to extract data from the wireless signals, and the display driver is configured to control the two-dimensional array of pixel cells in accordance with the data extracted from the wireless signal.

11. The vehicle of claim 1, further comprising:
a computer device configured to store data about the vehicle and driving conditions; and
a display driver configured to control the two-dimensional array of pixel cells in response to the data stored in the computer device.

12. The vehicle of claim 1, wherein the light source comprises a Xenon lamp, a halogen lamp, or a light emitting diode.

13. A vehicle, comprising:
a headlight comprising a light source configured to emit light and a spatial light modulator (SLM) including a two-dimensional array of pixel cells, wherein each of which is configured to produce an image pixel in a display image in front of the vehicle;
a computer device configured to store first data about the vehicle and driving conditions;
an antenna configured to receive wireless signals;
a receiver coupled to the antenna that is configured to extract second data from the wireless signals; and
a display driver configured to control the two-dimensional array of pixel cells in response to at least one of the first data or the second data.

14. The vehicle of claim 13, wherein one of the pixel cells in the SLM is configured to reflect the light emitted from the light source to form the image pixel in the display image.

15. The vehicle of claim 14, wherein at least one of the pixel cells in the SLM comprises a tiltable mirror supported by a substrate, wherein the tiltable mirror is configured to be tilted to an “on” position to reflect the light emitted from the light source to form an image pixel in the display image and to be tilted to an “off” position to reflect the light emitted from the light source away from the display image.

16. The vehicle of claim 13, wherein one of the pixel cells in the SLM is configured to transmit the light emitted from the light source to form the image pixel in the display image.

17. The vehicle of claim 16, wherein the SLM comprises a transmissive liquid crystal device.

18. The vehicle of claim 13, wherein the headlight further comprises a mirror configured to reflect the light emitted from the light source toward the SLM.

19. The vehicle of claim 13, wherein the light source comprises a Xenon lamp, a halogen lamp, or a light emitting diode.

20. The vehicle of claim 13, wherein the headlight further comprises a projection system configured to project light from the SLM to form image pixels in the display image in front of the vehicle.

21. The vehicle of claim 13, wherein the display image is formed on a road surface in front of the vehicle.
